(19) United States
(12) Patent Application Publication
(10) Pub. No.: US 2011/0135414 A1
(43) Pub. Date: Jun. 9, 2011

(54) Method of increasing the fracture toughness of the outer layer of a carbide cutting bit of a drill

(76) Inventors: Wulf Pfeiffer, Teningen (DE); Till Cramer, Gams (CH); Amo Glaser, Buchs (CH)

(21) Appl. No.: 12/311,206

(22) PCT Filed: Sep. 19, 2007
(86) PCT No.: PCT/EP2007/008168

§ 371 Date: Feb. 18, 2011

(30) Foreign Application Priority Data
Sep. 28, 2006 (DE) 10 2006 046 263.7

(51) Int. Cl. B25D 17/02; B29C 59/02; B29C 59/04

(52) U.S. Cl. 408/199; 264/293

(57) ABSTRACT

A method of increasing fracture toughness of an outer layer of a carbide cutting bit of a drill for impact drilling of hard materials, preferably of rock or concrete. The invention is characterized by combination of the following steps:
providing a drill having a finished-contoured carbide cutting bit;
treating at least one partial region of the finished-contoured carbide cutting bit by introduction of mechanical energy at a surface by using a plurality of non-sharp-edged tools with a tool diameter of up to 6 mm and directing them onto the at least one partial region of the carbide cutting bit with a predetermined metered intrinsic pulse thereby carrying out deformation of the outer layer of the partial region, with introduction of only local plastic deformation into the outer layer while preventing formation of cracks within the outer layer of the treated region of the carbide cutting bit.

### TECHNICAL FIELD

The invention relates to a method of increasing fracture toughness of the outer layer of a carbide cutting bit of a drill for treating hard material, preferably, rock and concrete, and to a drill produced by the method.

### STATE OF THE ART

Drills for treating hard materials such as, e.g., hardened steel, chilled iron, fiber-reinforced composite materials, rock, concrete and the like, consist of steel shaft provided with a cutting bit or an entire boring crown of carbide and secured thereon preferably by welding or soldering.

This cutting bit or crown, because of the high hardness and high wear resistance of the carbide, is suitable for cutting and also a partial destruction of hard materials to thereby provide for removal of material. The output capacity of a drill depends first of all on material characteristics of the carbide. The methods of increasing the output capacity of the cutting bit up to now were limited to geometrical shape of a cutting bit, composition of the carbide in the sense of the material combination and the grain size, and by retaining advantageous drilling parameters.

The carbide cutting bits are subjected during drilling to complex stresses which follow from partially contradictory requirements for optimization of the material: thus, an adequate toughness of material is required in course of impact loading or embossed loading of the cutting bit during impact drilling in order to prevent brittle fracture of the cutting bit. The ability to be able to withstand a strong abrasive load during treating hard materials requires a high hardness of the carbide. In an attempt to achieve both material characteristics simultaneously by classical means of material development, clear limits are set for purposes of optimization. Big advances could not be expected any more in this area because the materials are already developed to a most possible extent.

German Publication DE 199 05 735 A1 discloses a method of manufacturing of cutting tools in which the drill tip is coated with a hard material layer. The object is to improve adhesion between the tool and the hard material layer. It was proposed to subject the tool and, in particular, the tool tip before the coating process to microblasting. As a blasting or peening medium, sharp-edged particles of aluminum oxide with a grain size between 5 μm and 50 μm are used. The microblasting increases the surface roughness which is necessary for the improved adhesion of the hard material layer, which is to be deposited, to the etched surface, with hard material layer being preferably produced by PVD-process. Such measures are known. This document discloses a cutting tool that during sliding across of a to-be-treated surface of a workpiece, causes an intended removal of the material. Such tools are basically subjected to smaller mechanical stresses than is the case with drills.

German Patent DE 196 52 872 C2 discloses a method of increasing the strength of the outer layer on surfaces from brittle hard materials and, in particular of workpieces consisting of ceramic materials.

German Publication DE 101 23 554 A1 discloses a process of manufacturing of cutting tools. The publication refers to tools with a much smaller and mechanical load applied thereto, and, thus, subjected to a smaller wear than drills. Besides, known cutting tools formed e.g., of carbide contemplate use of a hard material layer.

### DESCRIPTION OF THE INVENTION

Accordingly, an object of the invention to provide measures which would make possible to provide a drill for impact drilling of hard material, preferably, a compound drill, with a carbide cutting bit having a noticeably higher toughness at least at the same hardness.

The object of the invention is achieved with a solution given in claim 1. The subject matter of claim 12 is a drill according to the inventive solution.

According to the invention, a compound drill with a functional carbide surface with introduced compressive internal stresses is produced by combination of the following steps:
providing a drill having a finished-contoured carbide cutting bit, and treating at least one partial region of the finished-contoured carbide cutting bit by introduction of mechanical energy at a surface by using a plurality of non-sharp-edged tools with a tool diameter from 0.15 to 0.6 mm, preferably, from 0.3 to 4 mm, and directing them onto the at least one partial region of the carbide cutting bit with a predetermined metered intrinsic pulse, thereby carrying out deformation of the outer layer of the partial region, with introduction of only local plastic deformation into the outer layer while preventing formation of cracks within the outer layer of the treated region of the carbide cutting bit.

Advantageously, a steel shaft is connected in per se known manner with a finished-contoured carbide cutting bit or crown by open-joining method. “Finished-contoured” means here that no further bit sharpening treatment or coating steps for providing the bit with additional layers will be undertaken. Finally, the inventive surface treatment of functional surfaces of the carbide cutting bit or crown is carried out by applying, to the functional surface, a directed mechanical energy having treatment parameters adapted to the structure of the functional surface with regard to material and geometry, so that finally local plastic deformations are built in the outer layer.

This treatment increases the fracture toughness and, in a somewhat smaller degree, hardness of the outer layer of the carbide. In order to set the treatment parameters necessary for carrying out the method, preferably, three preliminary tests need to be conducted:

E.g., on a plate of the material suitable for forming the functional surface, dependence of a compression yield point and brittle fracture limit of the material on the tool geometry of a tool with which the functional surface is locally deformed, is determined, based on which, the necessary tool geometry, the necessary and maximum allowable force acting on the tool, and the hardness of the tool region which is brought into contact with the functional surface, are determined.

In a second step, within a limit of a multiple shot trust test, it is determined what number of repeated shot impressions per contact surface is permitable, without damaging the integrity of the outer layer of the functional surface but, at the same time, providing for plastic deformation of the outer layer. In this way, a permitable degree of superimposition, i.e., the number of tool impression per contact surface is set.

In a third step, by treating a specimen with edge-like geometrical components, is determined, based on treatment parameters obtained in the course of the preliminary test, further limitations for preventing relevant changes of the functional surface geometry.

As a tool material, a material with hardness similar to or higher than the hardness of the material used for the functional surface of the drill, is selected. As a tool shape, as smooth as possible rounded shape is selected for the contact region between the tool and the functional surface. It is not absolutely necessary to limit the tool geometry to a shot shape, other non-sharp-edged peening means of rounded, e.g., ellipsoidal, or the like shape can be used. After setting of the above described treatment parameters, the to-be related carbide functional surface is treated, e.g., by a shot peening process. The shot-shaped tool elements, which impact the functional surface, can impact the functional surface with set kinetic parameters by using a peening installation operated on compressed air or with a spinner drive, so that each point of the to-be-treated functional surface is treated once or several times.

The mechanical process is based, in particular, on the fact that the functional surface is locally deformed with a suitable tool, and compressive internal stresses are produced in the outer layer. It is essential that during carrying-out of mechanical surface treatment, together with the produced plastic surface deformations, simultaneously, no damages are caused in form of brittle fracture or material fatigue in the functional surface the strength reducing effect of which is greater than the strength-increasing effect of the compressive internal stresses produced by “plasticization”, and that the geometry of the functional surface is not unacceptably changed.

The above-mentioned requirement is met, on one hand, by limiting the plastic deformation to lateral, narrowly limited, functional surface regions and, on the other hand, by providing the tool, which contacts the functional surface of the to-be-treated workpiece, in the region of the contact surface with a predetermined contour that generally can be described as not being sharp-edged.

If a material-specific and dependent on the tool shape, limiting value of the contact surface between the tool and the layer surface and the impression depth of the tool in the outer layer are not exceeded, a desired effect of a specifically introduced plastic deformation of the outer surface can be achieved with a repeated, laterally offset, surface treatment.

The above-described requirement is particularly met with a tool having a suitable geometry, preferably, a round contour, and the critical tool diameter, dependent on the material of the to-be-treated functional surface, is not exceeded. In case of a shot, which is used in case of shot peening, and with the use of carbide as the layer material, maximum suitable shot diameter of 6 mm is established. The above-mentioned critical diameter, which is set for dimensioning of the shot, also defines the narrowly limited surface region within which the plastic deformation of the functional region takes place.

In addition to the geometrical dimensioning of the tool, with which the functional surface is treated, here as an alternative to the shot, hammers, nails and rollers can be named, the kinetic pulse introduced into the functional surface plays a big role, in particular, at shot-peening method. The geometry of the tool and the pulse setting, with which the tool impacts the to-be-treated functional surface, are so selected that the desired plastic deformation does not cause brittle fracture or material fatigue, i.e., the degree of the pulse introduction an the member of impacts per point are so determined that the amount of eventual damages are limited to such an extent that the positive influence of the plastic deformation and of the internal stresses on the strength and toughness in the region of the functional surface outweigh the eventual damages. The inherent in the material, strength and toughness characteristics of carbides, which are used for forming the functional surfaces, are noticeably improved by the inventive formation of compressive internal stresses in the functional surfaces in the course, e.g., of the above-explained shot-peening process.

### BRIEF DESCRIPTION OF THE INVENTION

The invention will now be described below, without limiting the general concept of the invention, based on exemplary embodiments with reference to the drawings. The drawings show:

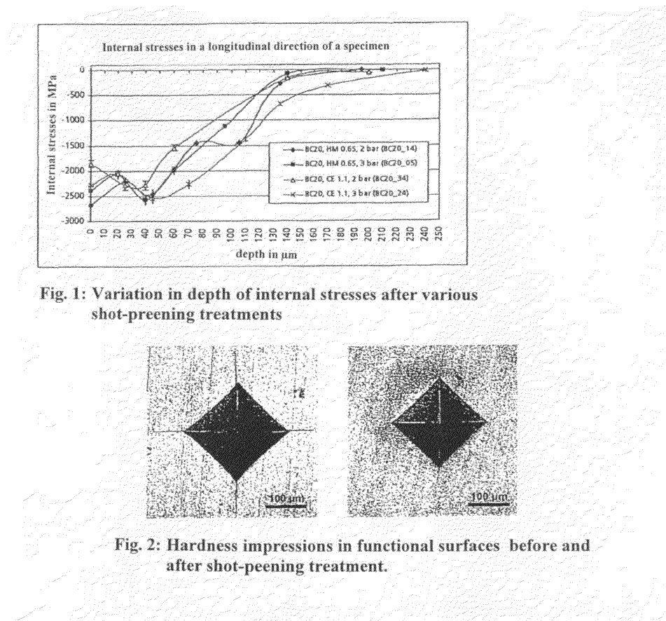

FIG. 1 a diagraph illustrating depth-dependent variation of internal stresses within a functional outer layer subjected to the inventive treatment;

FIG. 2 hardness impressions in functional surfaces before and after shot peening;

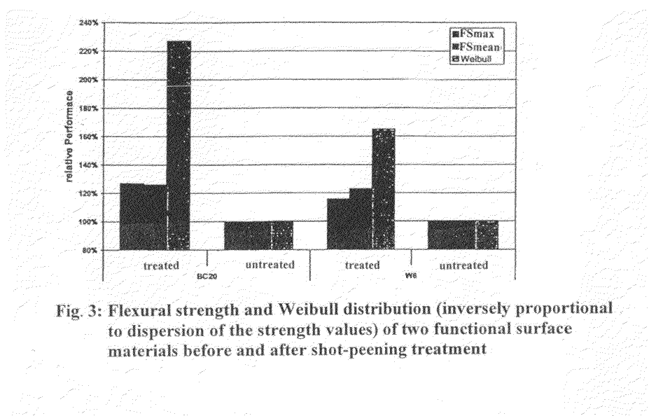

FIG. 3 flexural strength of two functional surface materials before and after peening.

### METHOD OF CARRYING OUT THE INVENTION, INDUSTRIAL APPLICABILITY

Flat specimen of a functional surface-relevant material were subjected to shot-peening treatment.

Internal stresses within the outer layer, which were caused by treatment, were determined by an incremental electrolytical removal of material and radiographic measurements. FIG. 1a shows favorable, extremely high, compressive internal stresses of up to 2,000 MPa which taper off at a depth of about 140 μm at an almost internal stress-free condition of the non-treated base material.

FIG. 2 and FIG. 3 show the improvement of mechanical characteristics of the functional surface which are achieved by the advantageous effect of treatment in accordance with the object of the invention.

An increase of the fracture toughness of the functional surface by at least of factor 2 is achieved. In the treated surfaces, no cracks suitable for causing plasticity can be produced by hardness impression, see FIG. 2, left picture.

The obtained flexural strength of treated (peened) and non-treated (non-peened) test specimen show increase of the flexural strength from 2,100 MPa to 2,600 MPa. This corresponds to an increase of up to 27% (FIG. 3).

Metallographic tests could show that the edge layers, which were treated according to the inventive solution, would not have any damage caused by treatment.

1. A method of increasing fracture toughness of an outer layer of a carbide cutting bit of a drill for impact drilling of hard materials, characterized by combination of the following steps:
providing a drill having a finished-contoured carbide cutting bit;
treating at least one partial region of the finished-contoured carbide cutting bit by introduction of mechanical energy at a surface by using a plurality of non-sharp-edged tools with a tool diameter of up to 6 mm and directing them onto the at least one partial region of the carbide cutting bit with a predetermined metered intrinsic pulse thereby carrying out deformation of the outer layer of the partial region, with introduction of only local plastic deformation into the outer layer while preventing formation of cracks within the outer layer of the treated region of the carbide cutting bit.

2. A method according to claim 1,
characterized in that the non-sharp-edged tools have a round form and are formed of a material having a comparable or higher hardness than the material of the carbide cutting bit.

3. A method according to claim 1,
characterized in that the plurality of non-sharp-edged tools are directed on the at least one partial region of the carbide cutting bit by using a shot peening method.

4. A method according to claim 1,
characterized in that shots are used as non-sharp-edged tools.

5. A method according to claim 1,
characterized in that hammers, nails, or rollers are used as non-sharp-edged tools.

6. A method according to claim 1,
characterized in that for the mechanical energy introduction at the surface, the following treatment parameters are determined dependent on shape and material of the to-be-treated carbide cutting bit: material and shape of the non-sharp-edged tools and the intrinsic pulse of the tools directed onto the at least one partial region of the carbide cutting bit.

7. A method according to claim 6;
characterized in that for determination of decisive treatment parameters, the following steps are performed:
on a piece of the to-be-treated carbide, dependence of a compression yield point and a brittle fracture limit on shape, material, and intrinsic pulse of tools, with which the piece is treated, are determined, and a number of allowable shot impressions per contact surface of the piece of the to-be-treated carbide, with which an allowable degree of superimposition on local plastic surface deformation is set, is determined by a shot trust test.

8. A method according to claim 7,
characterized in that the decisive treatment parameters are tested on at least one specimen with an edge geometry portions corresponding to to-be-treated carbide cutting bit in order to prevent formation of cracks within the outer layer of the specimen.

9. A method according to claim 1,
characterized in that a compound drill having a shaft on which a carbide cutting bit is installed before the cutting bit outer surface is treated, is used as the drill.

10. A method according to claim 1,
characterized in that the carbide cutting bit is formed as a carbide crown.

11. A method according to claim 1,
characterized in that the non-sharp-edged tools having each a tool diameter of from 0.15 mm to 6 mm, preferably, from 0.3 mm to 4 mm, are used.

12. A drill with a carbide cutting bit for treatment hard materials,
characterized in that at least one partial region of the cutting bit has local surface deformations which produce a compressive internal stress load in the outer layer of the carbide cutting bit.

13. A drill according to claim 12,
characterized in that the carbide cutting bit has functional surfaces containing deformations.

14. A drill according to claim 12,
characterized in that there is provided a drill shaft on which the carbide cutting bit is secured by welding or soldering technique.

15. A drill according to claim 12,
characterized in that the carbide cutting bit is formed as a carbide crown.

16. A drill according to claim 12,
characterized in that the drill is formed as a drilling tool for a manually or power-driven percussion drilling tool.
